(19) United States
(12) Patent Application Publication
(10) Pub. No.: US 2019/0180094 A1
(43) Pub. Date: Jun. 13, 2019

(54) DOCUMENT IMAGE MARKING GENERATION FOR A TRAINING SET

(71) Applicant: ABBYY Development LLC, Moscow (RU)

(72) Inventors: Ivan Zagaynov, Dolgoprudniy (RU); Pavel Borin, Tomsk (RU)

(21) Appl. No.: 15/849,294

(22) Filed: Dec. 20, 2017

(30) Foreign Application Priority Data
Dec. 13, 2017 (RU) 2017143593

(51) Int. Cl. G06K 9/00; G06K 9/46; G06K 9/62

(52) U.S. Cl. CPC G06K 9/00456; G06K 9/4676; G06K 2209/01; G06K 9/6262; G06K 9/6256

(57) ABSTRACT

Systems and methods for generating document image marking are disclosed. An example method comprises: identifying key points in each of a plurality of images; adding each image to one or more clusters, the adding comprising adding the key points one or more indices associated with the clusters wherein a minimum number of the key points correspond to key points in the indices; analyzing each of the images of the cluster as a candidate image by generating a marking along the boundaries of a document within a candidate image; verifying the marking by comparing the marking with boundaries of documents depicted within a number of other images in the cluster; and selecting the candidate image as the reference image when the marking is verified more than a predetermined number of times; and detecting a document marking along the boundaries of a document depicted within an input image using the reference image.

### REFERENCE TO RELATED APPLICATIONS

The present application claims the benefit of priority under 35 U.S.C. § 119 to Russian Patent Application No. 2017143593 filed Dec. 13, 2017, the disclosure of which is incorporated herein by reference in its entirety for all purposes.

### TECHNICAL FIELD

The present disclosure is generally related to image processing, and is more specifically related to systems and methods for generating document image marking and processing for subsequent uses, including, for use in machine learning models training.

### BACKGROUND

Machine learning enables computer systems to learn to perform tasks from observational data. Machine learning algorithms may enable the computer systems to learn without being explicitly programmed. Machine learning approaches may include, but not limited to, neural networks, decision tree learning, deep learning, etc. A machine learning model, such as a neural network, may be used in solutions related to image recognition, including optical character recognition. The observational data in the case of image recognition may be plurality of images. A neural network may thus be provided with training sets of images from which the neural network can learn image recognition.

### SUMMARY OF THE DISCLOSURE

In accordance with one or more aspects of the present disclosure, an example method for generating document image marking may comprise: receiving, by a computer system, a plurality of images depicting one or more documents; identifying one or more key points in each of the plurality of images; adding each of the plurality of images to one or more clusters, the adding to the one or more clusters comprising adding the one or more key points of each of the plurality of images to one or more indices associated with the one or more clusters wherein a minimum number of the one or more key points correspond to existing key points in the one or more indices; upon detecting that a cluster of the one or more clusters is saturated, analyzing each of the images of the cluster as a candidate image to generate a reference image, wherein the analyzing comprises: generating a marking along the boundaries of a document depicted within the candidate image; verifying that the marking is generated correctly by comparing the marking with boundaries of documents depicted within a number of other images in the cluster; and selecting the candidate image as the reference image when the marking is verified more than a predetermined number of times; and using the reference image, detecting a document marking along the boundaries of a document depicted within an input image.

In accordance with one or more aspects of the present disclosure, an example system for generating document image marking may comprise: a memory; a processor, coupled to the memory, the processor configured to: identify one or more key points in each of a plurality of images associated with documents; define one or more clusters comprising one or more images from the plurality of images, defining the one or more clusters comprising adding the one or more key points of each of the plurality of images to one or more indices associated with the one or more clusters wherein a minimum number of the one or more key points correspond to existing key points in the one or more indices; detect that a cluster of the one or more clusters is saturated when the cluster reaches a threshold number of images; upon detecting that the cluster is saturated, analyze each of the images of the cluster as a candidate image to generate a reference image, wherein the analyzing comprises: generate a marking along the boundaries of a document depicted within the candidate image; verify that the marking is generated correctly by comparing the marking with boundaries of documents depicted within a number of other images in the cluster; and select the candidate image as the reference image when the marking is verified more than a predetermined number of times; using the reference image, detect a document marking along the boundaries of a document depicted within an input image, and add the input image including the document marking to a training set of images for training a machine learning model.

In accordance with one or more aspects of the present disclosure, an example computer-readable non-transitory storage medium may comprise executable instructions that, when executed by a processing device, cause the processing device to: receive a plurality of images associated with documents; identify one or more key points in each of the plurality of images; add each of the plurality of images to one or more clusters, the adding to the one or more clusters comprising adding the one or more key points of each of the plurality of images to one or more indices associated with the one or more clusters wherein a minimum number of the one or more key points correspond to existing key points in the one or more indices; upon detecting that a cluster of the one or more clusters is saturated, analyze each of the images of the cluster as a candidate image to generate a reference image, wherein the analyzing comprises: generate a marking along the boundaries of a document depicted within the candidate image; verify that the marking is generated correctly by comparing the marking with boundaries of documents depicted within a number of other images in the cluster; and select the candidate image as the reference image when the marking is verified more than a predetermined number of times; and add the reference image including the marking to a training set of images for training a machine learning model.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1A depicts a high-level component diagram of an example system architecture, in accordance with one or more aspects of the present disclosure.

FIG. 1B depicts a flow diagram of one illustrative example of a method for generating document image marking, in accordance with one or more aspects of the present disclosure.

FIG. 2 illustrates examples of documents, in accordance with one or more aspects of the present disclosure.

FIG. 3 illustrates an example of boundary detection for two document images, in accordance with one or more aspects of the present disclosure.

FIG. 4 illustrates an example of filtering of excessive key points from an image, in accordance with one or more aspects of the present disclosure;

FIG. 5 illustrates an example reference image with marking, in accordance with one or more aspects of the present disclosure.

FIG. 6 depicts a component diagram of an example computer system which may execute instructions causing the computer system to perform any one or more of the methods discussed herein.

### DETAILED DESCRIPTION

Described herein are methods and systems for generating document image marking for training set of images for use in a machine learning model.

“Computer system” herein shall refer to a data processing device having a general purpose processor, a memory, and at least one communication interface. Examples of computer systems that may employ the methods described herein include, without limitation, desktop computers, notebook computers, tablet computers, and smart phones.

In the following description, the term “document” shall be interpreted broadly as referring to a wide variety of text-carrying media, including but not limited to printed or handwritten paper documents, passports, driver's license, banners, posters, signs, billboards, and/or other physical objects carrying visible text symbols on one or more of their surfaces. “Document image” herein shall refer to an image of at least a part of the original document (e.g., a page of a paper document).

A document may include a printed document, a digital document, etc. Printed documents are essentially images, while electronic documents contain sequences of numerical encodings of natural-language symbols and characters. It may be desirable to transform printed documents into electronic documents because electronic documents provide advantages in cost, transmission and distribution efficiencies, ease of editing and modification, and robust-storage over printed documents. Various methods are used to produce digital images of printed documents (e.g., text-containing documents). Digital images of printed documents produced by electronic scanners, hand-held devices and mobile computing devices (e.g., smart phones, digital cameras, video surveillance cameras, tablets, laptops, etc.) can be processed by image recognition systems. Additionally, digital images may be processed by computational optical character recognition systems, including optical character recognition applications to produce electronic documents corresponding to the printed documents.

Image recognition, including optical character recognition, may be performed using machine learning models. As an example, a neural network may be used as a machine learning model for image recognition. A machine learning model may be provided with sample images of documents as training sets of images which the machine learning model can learn from. These images may include digital images produced by electronic scanners, hand-held and mobile devices, as discussed above. The images may be associated with noise, non-standard position and orientation of the imaging device with respect to a document being imaged, optical blur, interfering objects, background images beyond intended document, and other defects and deficiencies. In order for the machine learning model to learn from the sample images, the sample images need to be marked to identify the intended document within the image. The marking may be provided along the boundaries of an intended document within an image. However, manually marking such images may lead to inefficiency, inaccuracy, error proneness, slowness and labor intensity. In addition, if the training set for the selected machine learning model requires a large number (e.g., hundreds or thousands) of document images, marking the documents in the images manually may add extensive overhead and/or outweigh the benefits of using the machine learning model.

The systems and methods described herein represent significant improvements by automatically generating markings of plurality of training images. The systems and methods herein provide the improvements by classifying and clustering similar images of documents based on key points identified within the images and selecting a reference image for each cluster. A marking on the reference image may be generated along the boundaries of the document or its parts depicted in the image and the correctness of the marking may be verified by comparing the reference image marking with markings of other documents depicted in other images in the cluster. Therefore, the systems and methods described herein may be efficiently utilized for processing various document images, including images captured by hand-held and mobile computing devices equipped with still image and/or video cameras, and marking such documents within the images automatically. The document image marking may be generated without human participation as well as independently verified for correctness, improving efficiency and accuracy, and minimizing resource overhead. The automatic generation of markings allows for inclusion of a vast number of different types of documents and images in a training set of images, improving the accuracy and usefulness of an image recognition system. The image processing effectively improves image recognition quality by compensating for various image aberrations. The image recognition quality produced by the systems and methods of the present disclosure allows significant improvement in the optical character recognition (OCR) accuracy over various common image acquisition methods.

In an illustrative example, a computer system implementing the methods described herein may obtain a plurality of images depicting documents. The image processing may involve searching for key points in each of the plurality of images. Each of the plurality of images may be added to one or more clusters based on a metric of similarity among key points in images. Each of the images of a cluster may be analyzed to build a reference image. A marking may be generated along the boundaries of a document depicted in a reference image. Excessive key points from the reference image may be filtered using an appropriate algorithm, such as, Random Sample Consensus (RANSAC), adaptive RANSAC, a frequency filter, etc. For example, excessive key points outside of the document marking may be eliminated to crop out the excessive key points from the image. Such filtration may be performed throughout various stages of implementing the method. The computer system may verify the marking is executed correctly to confirm the selection of the reference image. Clusters may be refined to exclude clusters for which the marked reference has already been obtained as well as duplicate clusters may be filtered out. When a document image marking reference is obtained, the reference image may be used to detect document marking on additional, random image inputs comprising documents of similar type as in the reference image. A document image marking for the document depicted in the reference image, as well as document marking for any other random images using the reference image, may be automatically generated for a machine learning model without human involvement by adding the reference image and/or the random image to a training set of images for training the machine learning model. The machine learning model may be a support vector machine, a neural network, etc. Once trained, the machine learning model can be used to automatically identify documents and document image markings for a new image depicting a document. The document may be further processed by an image recognition system to recognize the content inside the document marking.

Various aspects of the above referenced methods and systems are described in details herein below by way of examples, rather than by way of limitation.

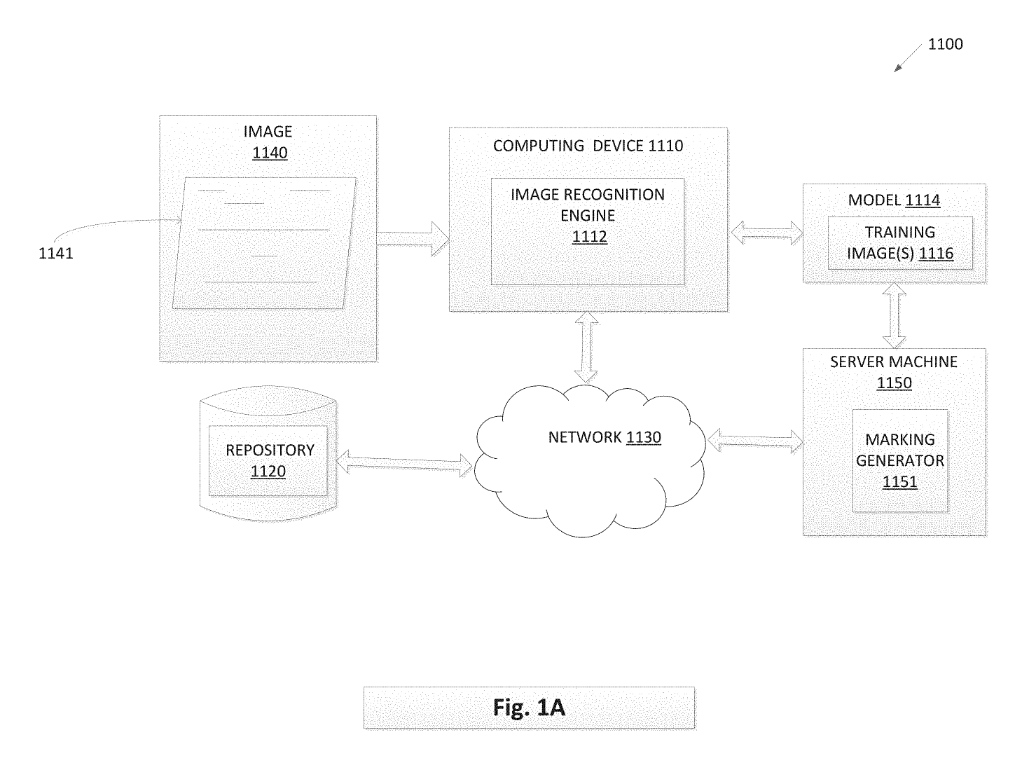

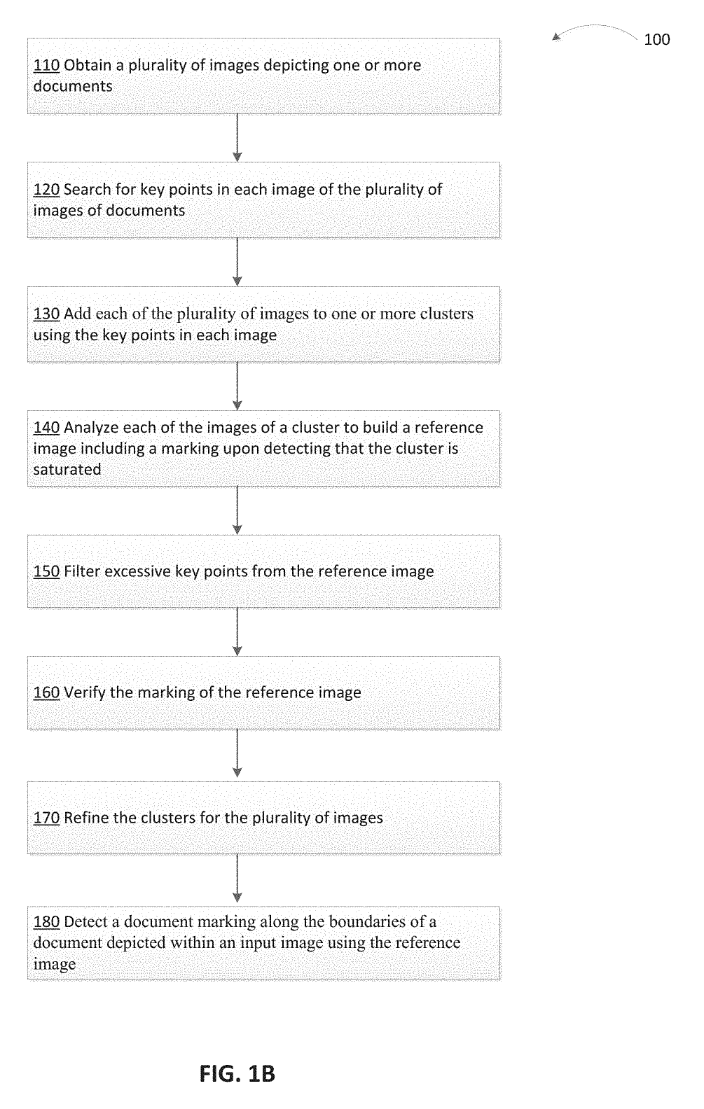

FIG. 1A depicts a high-level component diagram of an illustrative system architecture 1100, in accordance with one or more aspects of the present disclosure. System architecture 1100 includes a computing device 1110, a repository 1120, and a server machine 1150 connected to a network 1130. Network 1130 may be a public network (e.g., the Internet), a private network (e.g., a local area network (LAN) or wide area network (WAN)), or a combination thereof.

The computing device 1110 may perform image recognition, including character recognition. The computing device 1110 may be a desktop computer, a laptop computer, a smartphone, a tablet computer, a server, a scanner, or any suitable computing device capable of performing the techniques described herein. An image 1140 may be received by the computing device 1110. In one example, image 1140 may be a digital image depicting a printed document 1141. The image 1140 may include a document with one or more sentences each having one or more words that each has one or more characters. An image recognition performed by the computing device 1110 may include optical recognition of the one or more characters in the document.

The image 1140 may be received in any suitable manner. For example, the computing device 1110 may receive a digital copy of the image 1140 by scanning the document 1141 or photographing the document 1141. Additionally, in instances where the computing device 1110 is a server, a client device connected to the server via the network 1130 may upload a digital copy of the image 1140 to the server. In instances where the computing device 1110 is a client device connected to a server via the network 1130, the client device may download the image 140 from the server. The image 1140 may depict a document or one or more of its parts. In an example, image 1140 may depict document 1141 in its entirety. In another example, image 1140 may depict a portion of document 1141. In yet another example, image 1140 may depict multiple portions of document 1141.

The image 1140 may be used to train a set of machine learning models or may be a new image for which recognition is desired. Accordingly, in the preliminary stages of processing, the image 1140 including document 1141 can be prepared for training the set of machine learning models or subsequent recognition. For instance, in the image 1140, boundaries of document 1141 may be identified so that optical character recognition may be performed on the portion inside the boundaries of the document 1141. A document marking may be generated for document 1141 along the boundary lines of document 1141.

The computing device 1100 may include an image recognition engine 1112. The image recognition engine 1112 may include instructions stored on one or more tangible, machine-readable media of the computing device 1110 and executable by one or more processing devices of the computing device 1110. In an implementation, the image recognition engine 1112 may use a set of trained machine learning models 1114 that are trained and used to recognize image 1140, including contents of document 1141 of image 1140. The set of machine learning models 1114 may be trained using a training set of images 1116. The training set of images may be generated from received image 1140. The image recognition engine 1112 may also preprocess any received images prior to using the images for training of the set of machine learning models 1114 and/or applying the set of trained machine learning models 1114 to the images. In some instances, the set of trained machine learning models 1114 may be part of the image recognition engine 1112 or may be accessed on another machine (e.g., server machine 1150) by the image recognition engine 1112. Based on the output of the set of trained machine learning models 1114, the image recognition engine 1112 may recognize objects in image 1140, such as content of the document including one or more predicted words, sentences, logos, etc. from document 1141.

Server machine 1150 may be a rackmount server, a router computer, a personal computer, a portable digital assistant, a mobile phone, a laptop computer, a tablet computer, a camera, a video camera, a netbook, a desktop computer, a media center, or any combination of the above. The server machine 1150 may include a marking generator 1151. The set of machine learning models 1114 may refer to model artifacts, such as training images 1116 that have been marked by a marking generator 1151. In order for the set of machine learning models 1114 to be trained to recognize documents in images, a training image 1116 needs to identify a document within image 1116 by marking the document depicted in the image 1116. The marking generator 1151 may generate marking along the boundaries of a document depicted in image 1116 and provide the set of machine learning models 1114 with image 1116 that captures the marking. The set of machine learning models 1114 may be composed of, e.g., a single level of linear or non-linear operations (e.g., a support vector machine [SVM]) or may be a deep network, i.e., a machine learning model that is composed of multiple levels of non-linear operations. Examples of deep networks are neural networks including convolutional neural networks, recurrent neural networks with one or more hidden layers, and fully connected neural networks.

The set of machine learning models 1114 may be trained to recognize contents of image 1140 and document 1141 using training data. Once the set of machine learning models 1114 are trained, the set of machine learning models 1114 can be provided to image recognition engine 1112 for analysis of new images. For example, the image recognition engine 1112 may input the image of document 1141 obtained from the image 1140 being analyzed into the machine learning models 1114. The image recognition engine 1112 may obtain one or more final outputs from the trained machine learning models and may extract, from the final outputs, one or more predicted results for the document 1141. In an example, the predicted results may include a probable sequence of words and each word may include a probable sequence of characters.

The repository 1120 may be a persistent storage that is capable of storing image 1140 and/or document 1141 as well as data structures to tag, organize, and index the content of document 1141. Repository 1120 may be hosted by one or more storage devices, such as main memory, magnetic or optical storage based disks, tapes or hard drives, NAS, SAN, and so forth. Although depicted as separate from the computing device 1110, in an implementation, the repository 1120 may be part of the computing device 1110. In some implementations, repository 1120 may be a network-attached file server, while in other embodiments content repository 1120 may be some other type of persistent storage such as an object-oriented database, a relational database, and so forth, that may be hosted by a server machine or one or more different machines coupled to the via the network 1130.

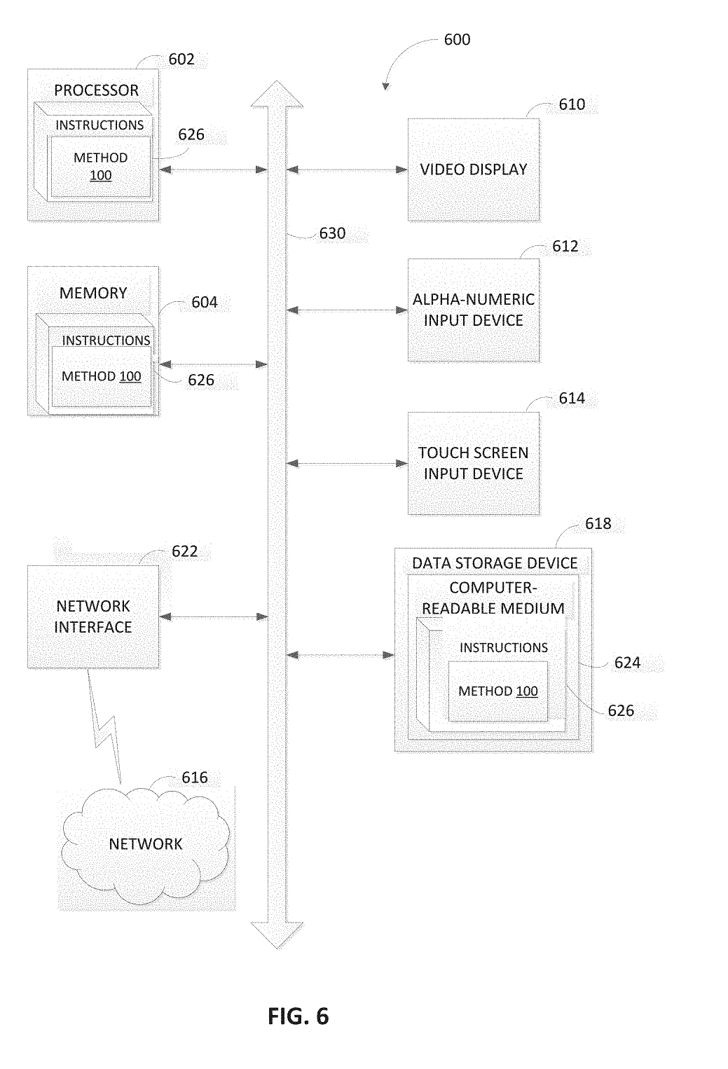

FIG. 1B depicts a flow diagram of one illustrative example of a method 100 for generating document image marking for a plurality of images of documents, in accordance with one or more aspects of the present disclosure. Method 100 and/or each of its individual functions, routines, subroutines, or operations may be performed by one or more processors of the computer system (e.g., example computer system 600 of FIG. 6) executing the method. In certain implementations, method 100 may be performed by a single processing thread. Alternatively, method 100 may be performed by two or more processing threads, each thread executing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other. Therefore, while FIG. 1B and the associated description lists the operations of method 100 in certain order, various implementations of the method may perform at least some of the described operations in parallel and/or in arbitrary selected orders. In one implementation, the method 100 may be performed by the marking generator 1151 of FIG. 1B.

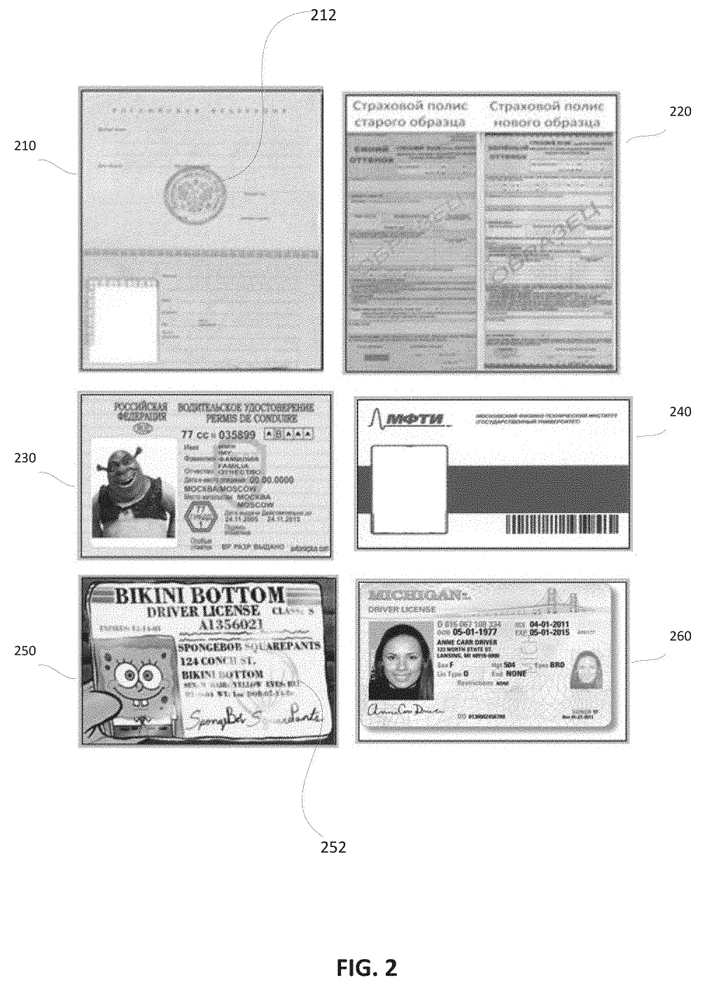

At block 110, the computer system implementing the method may obtain a plurality of images of documents. The plurality of images may depict different types of documents. For example different types of documents may include, but not be limited to, passport, driver's license, identification cards, insurance card, certificates, etc. For example, FIG. 2 illustrates various documents 210, 220, 230, 240, 250, and 260. These documents may be printed documents. Digital images of such documents may be produced using various methods and devices, such as an electric scanner, smart phone, digital camera, etc. Acquiring the images may be performed by still image or video cameras. Digital images depicting the documents may be fed to the computer system as a plurality of images of documents.

Varying the position of the image acquiring device with respect to the original document, or vice versa, may produce differences in the image angle, scale, different image optical distortions caused by variations in the shooting angle, different positions of the original document within the image and/or different positions of various visual artifacts, such as glare or shadows. Additionally, variations in image capturing conditions may be caused by differences in shutter speed, aperture, focus, and/or presence of external objects that at least partially cover the original document, which may result in variations in image brightness, sharpness, glaring, blur, and/or other image features and visual artifacts. These factors may add to the differences that exist between various images of the same or similar documents.

Each of the plurality of images may depict a document or one or more of its parts. In an example, an image may depict a document in its entirety. In another example, an image may depict part of a document. For example, the image may depict half of a document, such as, half a page from a passport. Some of the plurality of images may depict the same document, while some may depict similar types of documents, while some may depict completely different types of documents. Some of the documents may share many characteristics, features, or elements, while other may share few. Images that may depict the same document may share the most number of features, although there may still be some difference because of various reasons, such as, the varying position of image capturing devices, variation in image capturing conditions, etc. as described above. Documents of the same type may share a significant number of features. For example, documents 230, 250 and 260 of FIG. 2 are examples of driver's licenses, where features such as photos, identification numbers, signatures, logos, headings, etc. may be in common. A document of a different type, for example document 210 and 220, as compared to documents 230, 250 and 260, may have some features that are still similar, and many features that do not match. For example, document 210 contains a logo 212, and document 250 also includes a logo 252. However, the two documents also have many other features that are not shared.

The plurality of images may be obtained from different sources. For example, the images may belong to an existing folder of a computer system, a dynamic receipt repository in a distributed system, a single system of the passport office, the traffic police server, etc. The images may include documents such as a logo, vehicle license plate, banner, etc. An image may contain a single document, multiple pages of a single document, or multiple documents. The plurality of images may be input into the computer system implementing the method described herein. The images may be input one at a time, one after the other, or in a batch.

At block 120, the computer system may search for key points in each image of the plurality of images of documents. A “bag of visual words” (BoW) model may be used to represent each image for searching for key points in the images. An image may contain various features. In a BoW model, image features are treated as visual words. A “bag of visual words” is defined as a vector of occurrence counts of a vocabulary of local image features. That is, the empirical distribution of visual words may be captured by counting how many times each visual word in the visual vocabulary occurs within a particular image.

For each image of the plurality of images represented by a “bag of visual words,” a number of key points may be extracted. Key points may be locations, or points, in an image that stands out within the image. Key points of an image may correspond to the various features or visual words in the bag of visual words for that image. Key points may be distinctive invariant features of an image. A particular number of key points may be identified and extracted from each image. The particular number may be a predetermined numeric value, or a percentage of a total number of key points in the image. The identified key points may be the centroids of words in the bag of visual words for the image.

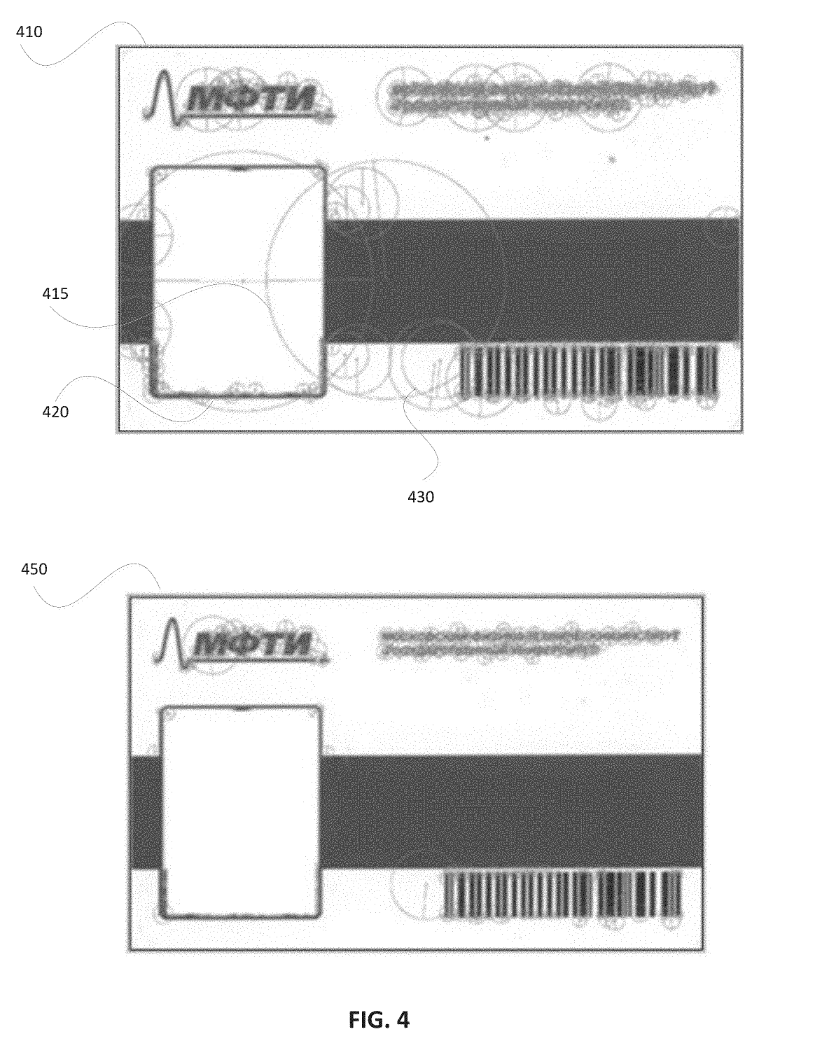

In an illustrative example, the computer system may search for key points in an image of document 240 shown in FIG. 2. As a result of the search, the computer system may identify features or visual words within the image and key points corresponding to those features. For example, as shown in FIG. 4, the computer system may identify key points represented by the various circles in image 410 of document 250 (shown in FIG. 2), such as key points 415, 420, and 430.

For each identified key point, one or more key point descriptors, represented by vectors describing the image data in the visual proximity of that key point, may be determined. To facilitate the feature point matching across multiple images, feature point descriptors may be chosen to be invariant to the illumination, noise, camera position and rotation, and/or other factors that may cause image distortion. In various illustrative examples, one or more methods may be employed for identifying key points and producing their corresponding descriptors, e.g., scale-invariant feature transform (SIFT), Binary Robust Invariant Scalable Keypoints (BRISK), Affine-SIFT (ASIFT), speeded up robust features (SURF), Oriented FAST and Rotated BRIEF (ORB), etc.

Application of SIFT algorithm to an image, for example, may generate a set of key points, which may be essentially annotated points within the image, having coordinates (x,y) relative to image coordinate axes generally parallel to the top and left-hand edges of the image. These points are selected to be relatively invariant to image translation, scaling, and rotation and partially invariant to illumination changes and affine projection. In addition to extracting key points from the image, additional features from an image may be extracted, such as presence or absence of another photo, angles, spots, etc. Further techniques for calculating key point descriptors and extracting additional features may be implemented in accordance with one or more aspects described in U.S. patent application Ser. No. 15/279,903, the entirety of which is incorporated herein.

At block 130, the computer system may add each of the plurality of images to one or more clusters using the key points in each image. Clustering may consist of splitting a set of images into groups. The groups may be associated with key points of the images and descriptors of the key points. In some implementations, clustering may be implemented such that within each group, there may be images corresponding to a given metric of similarity. In an implementation, a cluster quality metric may be defined to which the clustering is to adhere to. For example, the cluster quality metric may be characterized by a measure of precision and recall. In one implementation, a cluster may be required to have a minimum precision and/or recall value. Precision may be defined as the number of correctly assigned images to a given cluster, divided by the total number of images in the cluster. Recall may be defined as the number of correctly assigned images to a given cluster divided by the total number of images that could possibly be correctly assigned to the cluster. Precision and recall, as used in the disclosure, may be expressed as follows:

$$Precision = \frac{\vert \{ images correctly assigned to a cluster \} ⋂ \{ images in the cluster \} \vert}{\vert \{ images in the cluster \} \vert}$$

$$Recall = \frac{\vert \{ images correctly assigned to a cluster \} ⋂ \{ images in the cluster \} \vert}{\vert \{ all images that can be correctly assigned to the cluster \} \vert}$$

Each of the plurality of images may be grouped into one or more clusters one image at a time. In an implementation, each cluster may be associated with an index. For each image of the plurality of images, the identified key points of the images may be added to an index associated with a cluster. As an illustrative example, key points may be added to a Locality Sensitive Hashing (LSH) index. LSH reduces dimensionality of highly dimensional data and inputs items so that similar items map to the same group with high probability. An LSH index includes the construction of hyperplanes for key points. A hyperplane is a subspace of one dimension less than its ambient space. That is, if a space is 3-dimensional, then its hyperplanes are the 2-dimensional planes, and if a space is 2-dimensional then its hyperplanes are the 1-dimensional lines.

In some implementations, the identified key points of an image may be added to one or more indices associated with one or more clusters. For example, multiple LSH indices may be used. In an example, multiple LSH indices with different preset parameters may be used. Preset parameters dictate the number of hyperplane and the number of key points for a given index.

In an implementation, identified key points from an image that is currently being clustered may be assessed against one or more existing indices. Identified key points may be added to a given index when key point descriptors for the current image match existing key point descriptors of key points included in the given index. In some implementations, the descriptors of the current image and the centroid within the given index may be considered to match when a minimum number of key points from the current image correspond to existing key points in the given index.

In certain implementations, Hamming distance between two key points is calculated to assess whether two key points correspond to each other. The Hamming distance measures the number of disagreement between two vectors. For example, the Hamming distance between two strings of equal length is the number of positions at which the corresponding symbols are different. In some implementations, if the Hamming distance between key point descriptors of a particular key point of the current image and a particular key point of the given index is less than a predefined threshold value, then the two key points may be considered to match or correspond to each other. In certain implementation, matched pairs may be filtered according to a given Hamming distance. The filtering may minimize false matches.

In an implementation, one or more indices may be initialized. Initialization may consist of assignment of an initial value for the indices. A hash value may be assigned to a key point descriptor based on the index to which it belongs to.

In some implementations, key points of the current image may be assessed against all existing indices associated with one or more clusters. If the key points of the current image are considered to coincide (e.g., match) with key points in more than one index, the coinciding key points of the current image may be added to each index where a match is found. If no match is found, a new cluster may be created and the key points may be added to an index associated with the new cluster.

Subsequent images of the plurality of images may be assessed against each of the existing indices. Key points of subsequent images may be compared to key points in the existing indices in accordance with the implementations described above. If the key points correspond to key points of any of the indices, the key points of the subsequent image may be added to each of the corresponding indices.

In certain implementations, statistics may be collected regarding the number of descriptors entering each cluster across the set of key point descriptors. As an illustrative example, a descriptor-cluster table may be used to record the statistics of descriptor entry within the cluster. In some implementations, the descriptor entry statistics may be used to assign images to a certain cluster. For example, the computer system may add an image to a certain cluster if that certain cluster has a large number of descriptor matches for the image. In some implementations, some criteria may be set to identify a large number of matches. The computer system may define a numeric value or a percentage of matches as the criteria. In certain implementations, when an image is assigned to a certain cluster based on large number of key point matches, key points of the image which did not originally belong in the index associated with the certain cluster may also be added to the index and marked as belonging to the cluster.

In some implementations, key points of an image may correspond to more than one indices associated with more than one cluster. The image may be added to each of the clusters where there is a match and the key points of the images may be added to each of the corresponding indices. In some implementations, if an image is to be added to a predetermined number or percentage of clusters, the image may be added to all of the existing clusters. In some implementations, no match is found for an image in the existing clusters, then a new cluster may be created for the image and the image may be added to the new cluster. In an illustrative example, no match may be found in any existing cluster for an image when the features of the image are different from all the previously clustered images.

In certain implementations, the computer system may define a criteria or coincidence measure by which the determination to add an image to a cluster may be made. As an illustrative example, the computer system may configure a measure M, wherein if more than M % of the key points of an image are in cluster C, then the computer system assigns cluster C to all key points of the image. For example, the criteria may be equal to 60%, 70%, 80%, or other configurable measures. In another example, the computer system may configure a measure K, wherein if more than K % of key points of an image are not added to one of the existing clusters, then a new cluster is created for all the key points in that image. In yet another example, the computer system may configure a number N, wherein if all key points of an image are added to more than N clusters, then the computer system may remove the key points from the index. The measure M, the measure K, and/or the number N may be configurable or be predetermined measures by the computer system.

In some implementations, when adding a new image to a cluster, the cluster may be monitored to detect whether the cluster is saturated. A measure of saturation of a cluster may be configurable or be a predetermined measure by the computer system. A cluster may be considered saturated when the cluster reaches a certain number of images. The computer system may define a threshold for the number of images to consider a cluster saturated. In an example, the cluster may be considered saturated if the cluster contains 12, 13, 14, 15, or another configurable or predetermined number of images.

At block 140, the computer system may analyze each of the images of a cluster to build a reference image including a marking upon detecting that the cluster is saturated. If the cluster is saturated, an interclass geometry check may be provided for all images within the cluster prior to building the reference image. The reference image may be constructed in the cluster after the interclass verification of the geometry of images using, for example, the RANSAC algorithm on matched pairs. In certain implementations, each of the images of documents may be sequentially considered as a candidate image for building the reference image. In some implementation, additional key points may be extracted from an image in addition to the key points already extracted for clustering purposes. For example, a photo or an additional number of key points may be extracted that are associated with a document depicted in the image.

In some implementations, analyzing the images to build a reference may include comparing each candidate image of a document to all other images of documents. Key points of the current candidate may be compared with key points of all the other document images within the cluster. The comparison may identify one document image that is the best match for all the images in the cluster. In an illustrative example, Fast Library for Approximate Nearest Neighbors (FLANN) algorithm may be used based on k-d trees. The FLANN library contains a collection of algorithms optimized for fast nearest neighbor search in large datasets. A k-d tree is a space-partitioning data structure for organizing points in a k-dimensional space. Using the FLANN library, an initial image may be selected from the cluster to build a reference image. Applying the algorithm, the initial image may be compared to each of the remaining images in the cluster to find the nearest matching image. Each subsequent image may be compared to the other images in the cluster in the same manner until the best match is found from the aggregated comparison. Other algorithms in this respect may include, but are not limited to SIFT, BRISK-LSH, etc. In some implementations, the remaining photos extracted for the image may be used when building a reference image, however, the additional photos or other features may not be necessary in identification of the image as a reference image.

In an implementation, the computer system may use the initial identified image to build a reference image. In a certain implementation, a reference image may comprise a document image containing an aligned document. In an example, the document image may contain only static fields. A static field may be a field that is inherent to a particular type of a document. A static field may include image features that are common to all documents of a particular document type. Examples of static fields may include a “photo” field on a driver's license document, a “name” field on a passport document, etc. In some implementations, the reference image may not contain any extra features other than the features of the document depicted therein. In some implementations, the reference image may be constructed using further techniques implemented in accordance with one or more aspects described in U.S. patent application Ser. No. 15/279,903, which is incorporated in this disclosure.

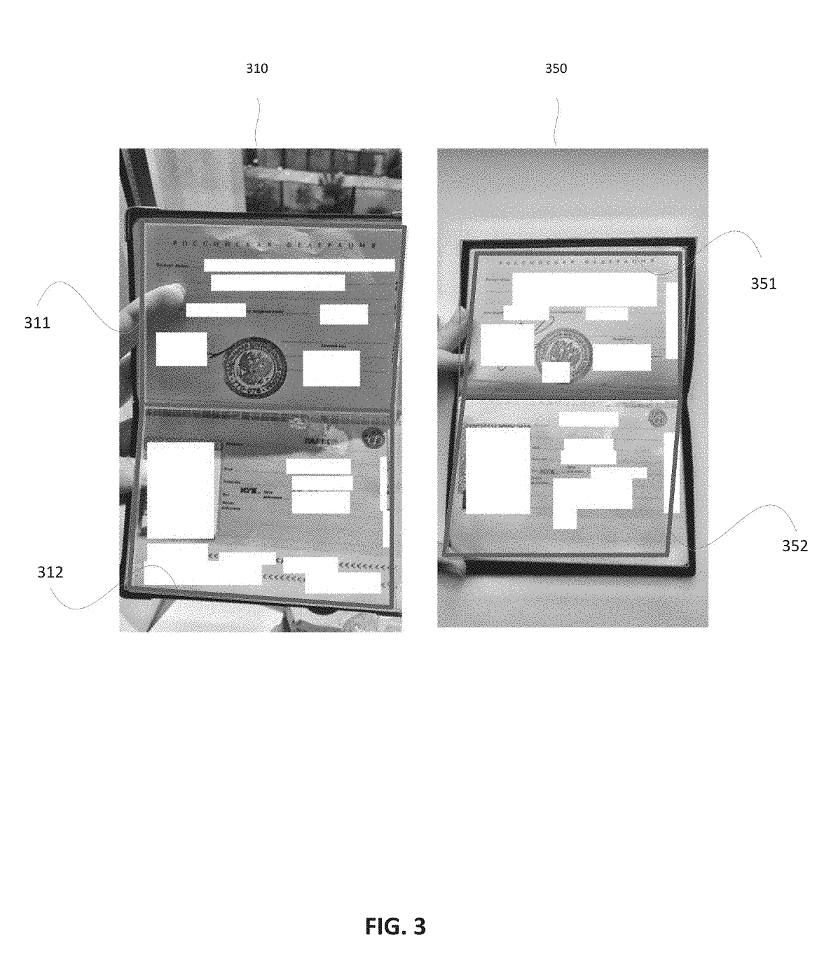

In an implementation, after a reference image is built using a document image of the cluster, the computer system may define a marking to identify the document that is depicted within the reference image. For example, a marking along the boundaries of the document depicted in the reference image may be generated. The marking may be used as a standard reference markup that may be used for marking documents of similar type. In an implementation, a mechanism for finding boundaries of a document may be launched. As illustrated in FIG. 3, the computer system may identify boundaries for the document depicted in image 310 wherein the boundaries are represented by the frames 311 and 312. Similarly, boundaries are illustrated by frames 351 and 352 for the document depicted in image 350. Further mechanisms for finding boundaries may be implemented in accordance with one or more aspects described in U.S. patent application Ser. No. 15/195,759, the entire disclosure of which is incorporated herein.

At block 150, the computer system may filter excessive key points from the reference image. Excessive key points may overfill memory. In various illustrative examples, one or more methods may be employed for identifying outliers within the set of key points for the reference image and to truncate the outliers, e.g., Random Sample Consensus (RANSAC), adaptive RANSAC, a frequency filter, etc. For example, FIG. 4 shows a reference image 410 prior to filtering the excessive key points, which include, for example, key points 415, 420, etc. FIG. 4 also shows a filtered reference image 450, where excessive key points 415 and 420, for example, have been filtered out of reference image 410.

At block 160, the computer system may verify the marking of the reference image. In one implementation, the marking may be verified by comparing the marking with boundaries of similar documents depicted within a number of other images. The images to compare the reference image may be selected from the same cluster as the reference image. In some implementations, a random sample of images may be selected. The number of images may be configurable. In some implementations, false positive matching pairs of images are checked. In an illustrative example, if the distance from the position of markup angles in the first image exceeds 10% from the image size to the corners on the subsequent image, then such marking may be considered a false positive matching. In an implementation, a marking of the reference image may be considered to have been executed correctly, and thus verified, when the marking matches with a certain threshold amount (e.g., 50%) of other marked documents to which the reference image is compared to. In another implementation, if the marking of the reference image has been confirmed with other marked documents more than a predetermined number of times, then such marking is verified as the marking reference image.

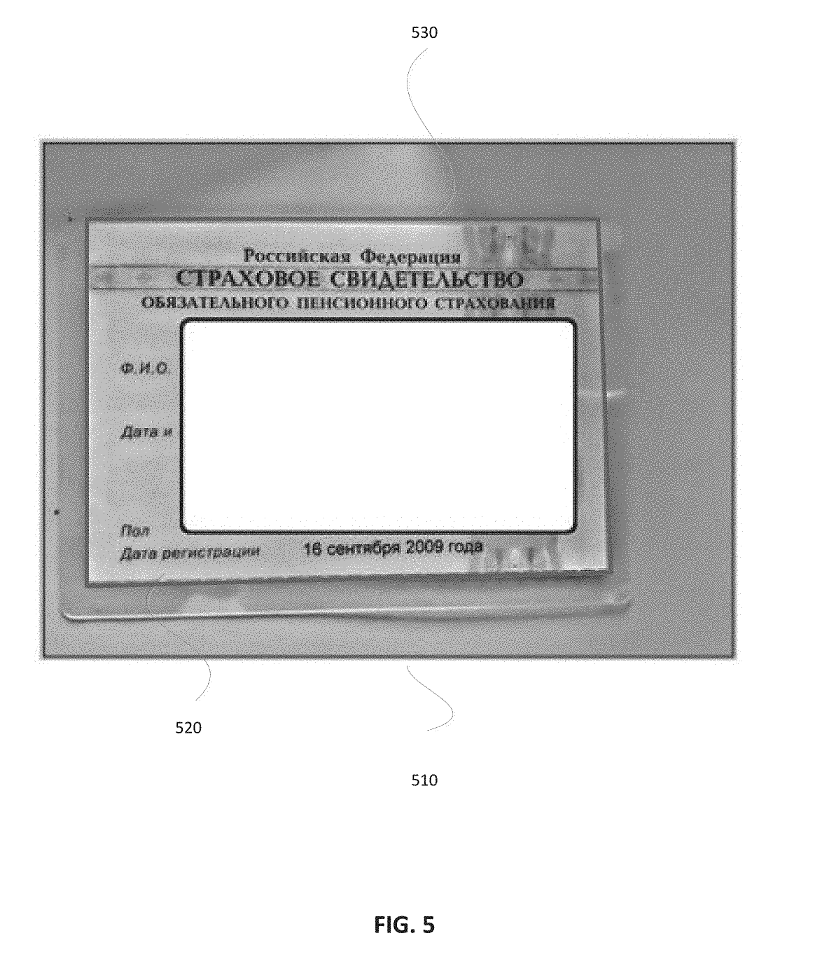

The reference image may include the marking of the document depicted within the reference image as identified and verified by the computer system. In an illustrative example, as shown in FIG. 5, an image 510 is identified as a reference image, and a marking for the document 520 depicted therein has been generated, the marking as represented by the frame 530 along the border of the document.

At block 170, the computer system may refine the clusters for the plurality of images. The refinement may comprise filtering extra indices associated with a cluster after obtaining a reference image. In one implementation, if a confirmed reference image is found for marking a document, then all clusters are checked to identify presence of the reference image therein. If the reference image is found in at least one or more additional clusters, then the cluster containing such an image may be excluded. This type of cluster refinement allows for dynamically reducing the dimensionality of the computer system when iteratively processing subsequent sets of images.

At block 180, the computer system may detect a document marking along the boundaries of a document depicted within an input image using the reference image. For example, the input image may include a random image. The document depicted within the input image may be a document of the same type as the document depicted in the reference image. The computer system may add the input image to a training set of images for training a machine learning model. The computer system may also add the reference image to the training set of images.

In some implementations, using the reference image, boundaries on random images comprising documents of similar types may be detected. For example, it may be possible to detect he boundaries of documents of the same type in other random images based on the ratio of document scales and angles between dominant directions. In an implementation, an image maybe input into the computer system for boundary detection. Key points from the input image may be extracted and key point descriptors may be calculated for each of the key points. Descriptor of the input image may be compared the descriptors of the trained markup reference image. For example, the comparison may utilize k-d trees, adaptive RANSAC, etc., as discussed before. In an example, the comparison may comprise selecting the best model of transformation M, for which the computer system may obtain a set of key points that satisfy the model. The model M maybe expressed as:

$$M = \{ \begin{matrix}A & D & a \\ B & E & b \\ C & F & c\end{matrix} \}$$

where M is an affine transition matrix to homogeneous coordinates (x, y),

A, B, D, and E are normalized coefficients (i.e., affine transformation coefficient without shift) for homogenous coordinates (x, y),

C and F are deflection affine transformation,

a and b are simple transformation, and

c is a normalized coefficient which provides solvability of the equation system.

$$M = \{ \begin{matrix}A & D & a \\ B & E & b \\ C & F & c\end{matrix} \}$$

The transformation model M is perspective, over a two-dimensional space. For example, with 4 pairs of points, 8 equations may be written. Thus the computer system may take c=1 for the above transformation model.

An equation may be created for each point X from the set of key points, as follows:

X_{transformed}=X_{reference}*M;

where X_{transformed} represents transformed point X of the input image; and

where X_{reference} represents point X of the reference point.

The transformation above may provide with a redefined system for the input image. In an example, the optimization problem related to the calculation is solved by using a method, such as, the least-squares (OLS) method with an initial approximation of M. The resulting transformation may be applied to the corner points (i.e., angular points) on the reference image, and the corresponding points on the input images (i.e., distorted images) may be obtained. The perspective distortion may be corrected, for example, by using an applicable method. In one example, an applicable method for correcting perspective distortions may be implemented in accordance with one or more aspects described in the previously referenced U.S. patent application Ser. No. 15/279,903.

Additionally, the computer system may detect new documents images entering the system and identify reference images for such images. The system may thus dynamically develop as new images are entered into the system. The reference image may be dynamically retrained when new sets of document images are added to the computer system. In an implementation, retraining may involve setting a counter indicating a number of images. In one example, the number of images may be a predetermined number. For instance, the number may be set as 30 or 45 images. In another example, the number of images may be in relation to the measure of saturation. For instance, the number may be two or three times the measure of saturation. In that case, if the measure of saturation is 15 images, and the counter dictates that the number of images is set to be three times the measure of saturation, then the number for retraining would be 45 images. After the counter has been reached, an attempt may be made to retrain the reference image. If the reference could not be retrained, for example because the marking on the reference could not be verified, then it may still be possible to return to the previous reference image as a fall back. If the retaining is successful, the new retrained reference is likely to be of a better quality. The computer system may also set a limitation for retraining, for example, a maximum number, such that once the maximum number is reached, the computer system may not attempt to further retrain the reference for the cluster. For example, the computer system may define a maximum number as 3 or 4 times the measure of saturation, such that after the cluster saturates more than 3 or 4 times, the computer system may not attempt retraining the reference.

The computer system may also be able to classify images of documents using the clustering mechanisms described in the disclosure. Additionally, the computer system may automate trimming of the outline of the documents on the reference image.

FIG. 6 depicts a component diagram of an example computer system which may execute instructions causing the computer system to perform any one or more of the methods discussed herein, may be executed. The computer system 600 may be connected to other computer system in a LAN, an intranet, an extranet, or the Internet. The computer system 600 may operate in the capacity of a server or a client computer system in client-server network environment, or as a peer computer system in a peer-to-peer (or distributed) network environment. The computer system 600 may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 600 includes a processor 602, a main memory 604 (e.g., read-only memory (ROM) or dynamic random access memory (DRAM)), and a data storage device 618, which communicate with each other via a bus 630.

Processor 602 may be represented by one or more general-purpose processing devices such as a microprocessor, central processing unit, or the like. More particularly, processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute instructions 626 for performing the operations and functions of method 100 for generating document image markings, as described herein above.

Computer system 600 may further include a network interface device 622, a video display unit 610, a character input device 612 (e.g., a keyboard), and a touch screen input device 614.

Data storage device 618 may include a computer-readable storage medium 624 on which is stored one or more sets of instructions 626 embodying any one or more of the methods or functions described herein. Instructions 626 may also reside, completely or at least partially, within main memory 604 and/or within processor 602 during execution thereof by computer system 600, main memory 604 and processor 6 also constituting computer-readable storage media. Instructions 626 may further be transmitted or received over network 616 via network interface device 622.

In certain implementations, instructions 626 may include instructions of method 100 for generating document image markings, as described herein above. While computer-readable storage medium 624 is shown in the example of FIG. 6 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying,” “generating” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, by a computer system, a plurality of images depicting one or more documents;
identifying one or more key points in each of the plurality of images;
adding each of the plurality of images to one or more clusters, the adding to the one or more clusters comprising adding the one or more key points of each of the plurality of images to one or more indices associated with the one or more clusters wherein a minimum number of the one or more key points corresponds to existing key points in the one or more indices;
upon detecting that a cluster of the one or more clusters is saturated, analyzing each of the images of the cluster as a candidate image to generate a reference image, wherein the analyzing comprises:
generating a marking along the boundaries of a document depicted within the candidate image;
verifying that the marking is generated correctly by comparing the marking with boundaries of documents depicted within a number of other images in the cluster; and
selecting the candidate image as the reference image when the marking is verified more than a predetermined number of times; and
using the reference image, detecting a document marking along the boundaries of a document depicted within an input image.

2. The method of claim 1, further comprising:
adding the input image including the document marking to a training set of images for training a machine learning model.

3. The method of claim 1, further comprising:
adding the reference image including the marking to a training set of images for training a machine learning model.

4. The method of claim 1, further comprising:
subsequent to selecting the reference image, identifying that at least one additional cluster of the one or more clusters include the reference image, and
removing the at least one additional cluster of the one or more clusters.

5. The method of claim 1, further comprising adding an image of the plurality of images to a new cluster wherein a minimum number of the one or more key points of the image does not correspond to existing key points in the one or more indices associated with the one or more clusters.

6. The method of claim 1, wherein the one or more indices include key points having a given metric of similarity.

7. The method of claim 1, wherein determining that the one or more key points correspond to existing key points in the one or more indices is in view of a hamming distance between the one or more key points and existing key points.

8. The method of claim 1, wherein the one or more indices are generated using different preset parameters.

9. The method of claim 1, wherein comparing the marking with boundaries of a number of other images in the cluster includes an indication of false positive matching.

10. The method of claim 1, wherein detecting that the cluster is saturated comprises detecting that the cluster includes a threshold number of images.

11. The method of claim 1, wherein the one or more identified key points in each of the plurality of images represent centroids of words in a bag of visual words for each of the plurality of images.

12. The method of claim 1, wherein the one or more indices associated with the one or more clusters comprise a locality sensitive hashing (LSH) index.

13. The method of claim 1, further comprising:
upon detecting that the cluster is saturated, providing an interclass geometry check for each of the images of the cluster prior to generating the reference image.

14. The method of claim 1, wherein identifying the one or more key points in each of the plurality of images comprises calculating one or more key point descriptors associated with the one or more key points.

15. A system, comprising:
a memory;
a processor, coupled to the memory, the processor configured to:
identify one or more key points in each of a plurality of images associated with documents;
define one or more clusters comprising one or more images from the plurality of images, defining the one or more clusters comprising adding the one or more key points of each of the plurality of images to one or more indices associated with the one or more clusters wherein a minimum number of the one or more key points correspond to existing key points in the one or more indices;
detect that a cluster of the one or more clusters is saturated when the cluster reaches a threshold number of images;
upon detecting that the cluster is saturated, analyze each of the images of the cluster as a candidate image to generate a reference image, wherein the analyzing comprises:
generate a marking along the boundaries of a document depicted within the candidate image;
verify that the marking is generated correctly by comparing the marking with boundaries of documents depicted within a number of other images in the cluster; and
select the candidate image as the reference image when the marking is verified more than a predetermined number of times;
using the reference image, detect a document marking along the boundaries of a document depicted within an input image, and
add the input image including the document marking to a training set of images for training a machine learning model.

16. The system of claim 15, wherein the processor is further configured to add an image of the plurality of images to a new cluster wherein a minimum number of the one or more key points of the image does not correspond to existing key points in the one or more indices associated with the one or more clusters.

17. The system of claim 15, wherein the determination that the one or more key points correspond to existing key points in the one or more indices is in view of a hamming distance between the one or more key points and existing key points.

18. The system of claim 15, wherein the reference image comprises static fields.

19. A computer-readable non-transitory storage medium comprising executable instructions that, when executed by a processing device, cause the processing device to:
receive a plurality of images associated with documents;
identify one or more key points in each of the plurality of images;
add each of the plurality of images to one or more clusters, the adding to the one or more clusters comprising adding the one or more key points of each of the plurality of images to one or more indices associated with the one or more clusters wherein a minimum number of the one or more key points correspond to existing key points in the one or more indices;
upon detecting that a cluster of the one or more clusters is saturated, analyze each of the images of the cluster as a candidate image to generate a reference image, wherein the analyzing comprises:
generate a marking along the boundaries of a document depicted within the candidate image;
verify that the marking is generated correctly by comparing the marking with boundaries of documents depicted within a number of other images in the cluster; and
select the candidate image as the reference image when the marking is verified more than a predetermined number of times; and
using the reference image, detect a document marking along the boundaries of a document depicted within an input image.

20. The storage medium of claim 19, wherein the one or more clusters include images having a given metric of similarity.

21. The storage medium of claim 19, wherein the processing device is further to:
add the input image including the document marking to a training set of images for training a neural network.
